(19) United States
(12) Patent Application Publication
(10) Pub. No.: US 2019/0354690 A1
(43) Pub. Date: Nov. 21, 2019

(54) SYSTEMS, DEVICES AND METHODS FOR APPLICATION AND PRIVACY COMPLIANCE MONITORING AND SECURITY THREAT ANALYSIS PROCESSING

(71) Applicant: ATRICORE INC., Sausalito, CA (US)

(72) Inventor: Gianluca BRIGANDI, Novato, CA (US)

(73) Assignee: ATRICORE INC., Sausalito, CA (US)

(21) Appl. No.: 16/466,811

(22) PCT Filed: Dec. 6, 2017
(86) PCT No.: PCT/US2017/064868

§ 371 Date: Jun. 5, 2019

Related U.S. Application Data
(60) Provisional application No. 62/431,649, filed on Dec. 8, 2016.

(51) Int. Cl. G06F 21/57; G06F 11/36; G06F 21/62

(52) U.S. Cl. CPC G06F 21/577; G06F 11/3612; G06F 2221/033; G06F 2201/88; G06F 21/6245

(57) ABSTRACT

Systems, devices and methods are disclosed that provide for continuously identifying, reporting, mitigating and remediating data privacy-related and security threats and compliance monitoring in applications. The system, devices and methods transparently detects and reports compliance violations at the application level. Detection can and operate by, for example, modifying the software application binaries at runtime using a binary instrumentation technique.

### CROSS-REFERENCE

This application claims the benefit of U.S. Provisional Application No. 62/431,649, filed Dec. 8, 2016, entitled Systems and Devices for Continuous and Consumption-Based Security Testing for Containerized Environments which application is incorporated herein by reference.

### BACKGROUND

Increasing interconnectivity—encompassing hundreds, or even thousands, of information systems interacting with one another in unpredictable ways—represents a significant software security challenge. Software systems are increasingly exposed to new and still unknown security threats. Many security threats are not detectable by available vulnerability scans or penetration tests.

While threat modeling can provide significant value to the stakeholders, threat modeling has a high barrier to entry for development and for the operations people. Threat modeling is typically implemented by security experts based on potentially incorrect or incomplete information of the software architecture, thus potentially rendering threat modeling completely ineffective. In addition, threat modeling tools and artifacts cannot be integrated into the software development lifecycle (SDLC) for automating security testing during product development. Threat modeling is also difficult for stakeholders to act upon. The output produced by threat modeling can be difficult to correlate to the actual corrective action needed. Thus it can be difficult to automatically generate meaningful security actions based the threat modeling output, mitigate security issues, or orchestrate auxiliary security-related processes.

Operating system (OS) virtualization technology is used intensively for software development, quality assurance and operations. In contrast, current security tools for environments are essentially vulnerability scanners which are not appropriate for addressing new threats that might occur deeper in the application stack or for securing OS containers at scale in both development and production on hundreds of machines. Critically, the usefulness of security tools for operating system virtualization environments is limited to detecting threats early in during the development of software.

Another problem limiting the adoption and effectiveness of security technology is the difficulty for non-subject matter experts to select the most appropriate technology. Additionally, not only do many current security solutions require specific skills and abundant resources in order to be effectively implemented, the solutions are relatively expensive.

What is needed are devices, systems and methods that provide automated security services in virtualized execution environments which can be used for software applications which are under development and throughout the software development cycle. Additionally, what is needed is a way to monitor software applications that are already deployed and running in a production environment for security vulnerabilities. What is also needed are application compliance and data privacy monitoring systems which transparently detect and report compliance violations at the application level.

### SUMMARY

The present disclosure relates to systems, devices and methods for providing automated security service tools for target software which is provided in a virtualized execution environment. The systems include components and software for automated architecture detection, retention and revision as needed. Threat analysis of the target software may be triggered either automatically (based on events originating in virtualized execution environment), or via user command. Upon discovery of threat(s), reporting is generated and/or stored, and an event is raised to monitoring applications and/or components. For security threats requiring introduction of additional security controls in the target software, an operating system container image can be automatically instantiated, deployed and executed within the virtualized execution environment. Should the discovered security threats require mitigation, operating system containers hosting potentially vulnerable services can be partially or totally sequestered, quarantined, or removed automatically.

The disclosed systems, methods and devices are also directed to application security and application data privacy compliance monitoring (ACM) systems which transparently detect and report compliance violations at the application level. The systems, devices and methods operate by modifying the application binaries using a binary instrumentation technique.

The systems, devices and methods of the present disclosure may be deployed via a wholly-owned model (i.e., user purchases software to use in their own computing environment or network) or as a security-compliance-monitoring-as-a-service model (i.e., user deploys the software via the internet). In the security-compliance-monitoring-as-a-service model, the subscriber (user) externalizes the software security and compliance testing and threat response of software applications under development by the subscriber and/or in operation to a cloud service provider. The subscriber deploys an agent (i.e., a computer program that acts for another program) within the computing environment—either hosted in the cloud or on the premises—to be monitored. The agent interacts with the security services offered by a cloud service provider. Subscriber may also access services programmatically via an application programming interface.

The systems of the present disclosure may be augmented by a cloud-based marketplace of security solutions. The marketplace hosts registered security solutions. Upon detection of one or more threats, security solutions capable of addressing said threats are suggested to subscriber. Subscriber selects one or more security solutions, either manually or programmatically via an agent. The security solutions marketplace system then creates an ad-hoc operating system container image, instantiating the chosen security solution and running it on the subscriber system to mitigate or eliminate the threat. The containerized security solution provides a privileged access to the control interface of the container infrastructure (e.g., the host). This allows for control of a lifecycle of containers, spawning of new containers, etc. A containerized application can, for example, create a new container image for an application that is running a vulnerable operating system in an existing container where the new container image includes a fix of the operating system. For applications outside the containerized environment, the security solution would access the application binaries and configuration by, for example, mapping a virtual volume in the container to one in the corresponding path within the host.

The systems, methods and devices disclosed perform threat model-based privacy analysis on an automatically discovered DFD from security-relevant traces originated from one or more trace data streams. The disclosed systems, methods and devices allow for deeper and more effective data privacy analysis by performing call graph analysis of captured call graphs using threat modeling. Additionally, the disclosed systems, methods and devices provide actionable mitigation and remediation strategies enabling the user to resolve reported data privacy issues.

An aspect of the disclosure is directed to apparatuses for implementation of a system for modeling and analysis in a computing environment, the apparatuses comprising: a processor and a memory storing executable instructions that in response to execution by the processor cause the apparatus to implement at least: identify elements of an information system configured for implementation by a system platform, the elements including components and data flows therebetween, the components including one or more of a host, process, data store or external entity; compose a data flow diagram for the information system, the data flow diagram including nodes representing the components and edges representing the data flows, providing structured information including attributes of the components and data flows; monitor an environment; receive a trace from the monitored environment; create an inventory of active and relevant computing assets; generate a topology of computing assets and interactions; store the topology in a catalog; and identify at least one of a privacy compliance and a security compliance of the monitored environment. Additionally, the apparatuses can further comprising: a compliance analyzer indicator configured to perform an analysis which includes being configured to: identify at least one of a measure of the privacy compliance and a measure of the security compliance of the environment, and identify at least one of a suggested mitigation and a suggested remediation wherein the suggested mitigation and suggested remediation are implementable to reduce at least one of the measure of the privacy compliance and the security compliance to a lower measure of privacy compliance and a lower measure of security compliance. In some configurations, a processor configured to at least one of automatically mitigating the data privacy compliance, automatically mitigating the security compliance, automatically remediating the data privacy compliance, and automatically remediating the security compliance. At least one of automatically mitigating the data privacy compliance, automatically mitigating the security compliance, automatically remediating the data privacy compliance, and automatically remediating the security compliance is based on a plug-and-play virtualized control in some configurations. Additionally, the privacy compliance and the security compliance can include a circumstance or an event with a likelihood to have an adverse impact on the environment, and the measure of a current risk is a function of measures of the privacy compliance and the security compliance. A processor can be provided which is configured to at least one of transparently monitoring the data privacy compliance, and transparently monitoring the security compliance. The at least one of transparently monitoring the data privacy compliance, and transparently monitoring the security compliance can include threat modeling of at least one of the data privacy compliance and the security compliance. The data privacy compliance monitoring can also be achieved with a binary instrumentation in some configurations. The security compliance monitoring can also be achieved with a network capture. In some configurations a compliance analyzer indicator is configured to: perform an analysis which includes being configured to: obtain execution environment-specific information from all the running applications within the environment; capture a flow of information between network objects; and generate facts from received flow information. Additionally, the apparatus can be configured to: generate meaningful facts from received execution environment-specific information. Generating meaningful facts can include a determination of the availability of software assets. The trace from the monitored environment can be at least one of a security-relevant trace and a data privacy-relevant trace from an application through an agent. Additionally, traces can be stored in a trace repository. One or more traces can be joined.

Another aspect of the disclosure is directed to methods of implementing a system for modeling and analysis in a computing environment, the methods comprising: activating a processor and a memory storing executable instructions that in response to execution by the processor cause the computing environment to: identifying elements of an information system configured for implementation by a system platform, the elements including components and data flows therebetween, the components including one or more of a host, process, data store or external entity; composing a data flow diagram for the information system, the data flow diagram including nodes representing the components and edges representing the data flows, providing structured information including attributes of the components and data flows; monitor an environment; receiving a trace from the monitored environment; creating an inventory of active and relevant computing assets; generating a topology of computing assets and interactions; storing the topology in a catalog; identifying at least one of a privacy compliance and a security compliance of the monitored environment. The methods can also comprise the steps of: identifying a measure of at least one of the privacy compliance and the security compliance of the environment, and identifying at least one of a suggested mitigation and a suggested remediation wherein the suggested mitigation and the suggested remediation are implementable to reduce at least one of the measure of the privacy compliance and the security compliance to a lower measure of the privacy compliance and a lower measure of the security compliance. In some configurations, the methods include the step of at least one of automatically mitigating the data privacy compliance, automatically mitigating the security compliance, automatically remediating the data privacy compliance, and automatically remediating the security compliance. At least one of automatically mitigating the data privacy compliance, automatically mitigating the security compliance, automatically remediating the data privacy compliance, and automatically remediating the security compliance can also be based on a plug-and play virtualized control. The privacy compliance and the security compliance can refer to a circumstance or an event with a likelihood to have an adverse impact on the environment, and the measure of a current risk is a function of measures of the privacy compliance and the security compliance. Additionally, some methods can include the step of at least one of transparently monitoring the data privacy compliance, and transparently monitoring the security compliance. The step of at least one of transparently monitoring the data privacy compliance, and transparently monitoring the security compliance can include threat modeling of at least one of the data privacy compliance and the security compliance. The data privacy compliance monitoring is also achievable with a binary instrumentation in some configurations. Security compliance monitoring can also be achieved in some configurations with a network capture. Methods can also include one or more of: obtaining execution environment-specific information from all the running containers within the container host; capturing a flow of information between network objects; and generating facts from received flow information. Additional method steps comprise: generating meaningful facts from received execution environment-specific information. Generating meaningful facts can include determining the availability of software assets. The trace from the monitored environment can be at least one of a data privacy trace and security-relevant trace from an application through an agent. Traces can also be stored in a trace repository. Additionally, one or more traces can be joined.

Still another aspect of the disclosure is directed to computer-readable storage mediums for implementing a system for modeling and analysis in a computing environment, the computer-readable storage medium being non-transitory and having computer-readable program code portions stored therein that in response to execution by a processor, cause an apparatus to at least: identify elements of an information system configured for implementation by a system platform, the elements including components and data flows therebetween, the components including one or more of a host, process, data store or external entity; compose a data flow diagram for the information system, the data flow diagram including nodes representing the components and edges representing the data flows, providing structured information including attributes of the components and data flows; monitor an environment; receive a trace from the monitored environment; create an inventory of active and relevant computing assets; generate a topology of computing assets and interactions; store the topology in a catalog; identify at least one of a privacy compliance and a security compliance of the monitored environment. Additionally, the program code can further comprising: a compliance analyzer indicator configured to perform an analysis which includes being configured to: identify at least one of a measure of the privacy compliance and a measure of the security compliance of the environment, and identify at least one of a suggested mitigation and a suggested remediation wherein the suggested mitigation and suggested remediation are implementable to reduce at least one of the measure of the privacy compliance and the security compliance to a lower measure of privacy compliance and a lower measure of security compliance. In some configurations, a processor configured to at least one of automatically mitigating the data privacy compliance, automatically mitigating the security compliance, automatically remediating the data privacy compliance, and automatically remediating the security compliance. At least one of automatically mitigating the data privacy compliance, automatically mitigating the security compliance, automatically remediating the data privacy compliance, and automatically remediating the security compliance is based on a plug-and-play virtualized control in some configurations. Additionally, the privacy compliance and the security compliance can include a circumstance or an event with a likelihood to have an adverse impact on the environment, and the measure of a current risk is a function of measures of the privacy compliance and the security compliance. A processor can be provided which is configured to at least one of transparently monitoring the data privacy compliance, and transparently monitoring the security compliance. The at least one of transparently monitoring the data privacy compliance, and transparently monitoring the security compliance can include threat modeling of at least one of the data privacy compliance and the security compliance. The data privacy compliance monitoring can also be achieved with a binary instrumentation in some configurations. The security compliance monitoring can also be achieved with a network capture. In some configurations a compliance analyzer indicator is configured to: perform an analysis which includes being configured to: obtain execution environment-specific information from all the running applications within the environment; capture a flow of information between network objects; and generate facts from received flow information. Additionally, the code can be configured to: generate meaningful facts from received execution environment-specific information. Generating meaningful facts can include a determination of the availability of software assets. The trace from the monitored environment can be at least one of a security-relevant trace and a data privacy-relevant trace from an application through an agent. Additionally, traces can be stored in a trace repository. One or more traces can be joined.

### INCORPORATION BY REFERENCE

All publications, patents, and patent applications mentioned in this specification are herein incorporated by reference to the same extent as if each individual publication, patent, or patent application was specifically and individually indicated to be incorporated by reference. See, for example,

US2005/0015752 A1 published Jan. 20, 2005, to Alpern et al. for Static analysis based error reduction for software applications;

US 2007/0157311 A1 published Jul. 5, 2007, to Meier et al. for Securing modeling and the application life cycle;

US 2007/0162890 A1 published on Jul. 12, 2007, to Meier, et al., for Security engineering and the application lifecycle;

US 2007/0266420 A1 published Nov. 15, 2007, to Hawkins et al. for Privacy modeling framework for software applications;

US 2009/0327971 A1 published on Dec. 31, 2009, to Shostack, et al., for Informational elements in threat models;

US 2011/0321033 A1 published Dec. 29, 2011, to Kelkar et al. for Application blueprint and deployment model for dynamic business service management (BSM);

US 2012/0117610 A1 published on May 10, 2012, to Pandya for Runtime adaptable security processor;

US 2013/0232474 A1 published on Sep. 5, 2013, to Leclair, et al., for Techniques for automated software testing;

US 2013.0246995 A1 published Sep. 19, 2013, to Ferrao et al. for Systems, methods and apparatus for model-based security control;

US 2015/0379287 A1 published on Dec. 31, 2015, to Mathur, et al., for Containerized applications with security layers;

US 2016/0188450 A1 published on Jun. 30, 2016, to Appusamy, et al., for Automated application test system;

US 2016/0191550 A1 published on Jun. 30, 2016, to Ismael, et al., for Microvisor-based malware detection endpoint architecture;

US 2016/0267277 A1 published on Sep. 15, 2016, to Muthurajan, et al., for Application test using attack suggestions;

US 2016/0283713 A1 published on Sep. 29, 2016, to Brech, et al., for Security within a software-defined infrastructure;

US 2017/0270318 A1 published Sep. 21, 2017, to Ritchie for Privacy impact assessment system and associated methods;

U.S. Pat. No. 7,890,315 B2 issued on Feb. 15, 2011, to Meier, et al., for Performance engineering and the application lifecycle;

U.S. Pat. No. 8,091,065 B2 issued on Jan. 3, 2012, to Mir, et al., for Threat analysis and modeling during a software development lifecycle of a software application;

U.S. Pat. No. 8,117,104 B2 issued Feb. 14, 2012, to Kothari for Virtual asset groups in compliance management system;

U.S. Pat. No. 8,255,829 B1 issued Aug. 28, 2012, to McCormick et al. for Determining system level information technology security requirements;

U.S. Pat. No. 8,285,827 B1 published Oct. 9, 2012, to Reiner et al. for Method and apparatus for resource management with a model-based architecture;

U.S. Pat. No. 8,539,589 B2 issued Sep. 17, 2017, to Prafullchandra et al. for Adaptive configuration management system;

U.S. Pat. No. 8,595,173 B2 issued Nov. 26, 2013, to Yu et al. for Dashboard evaluator;

U.S. Pat. No. 8,613,080 B2 issued on Dec. 17, 2013, to Wysopal, et al., for Assessment and analysis of software security flaws in virtual machines;

U.S. Pat. No. 8,650,608 B2 issued Feb. 11, 2014, to Ono et al. for Method for model based verification of security policies for web service composition;

U.S. Pat. No. 8,856,863 B2 issued on Oct. 7, 2014, to Lang, et al., for Method and system for rapid accreditation/reaccreditation of agile IT environments, for example service oriented architecture (SOA);

U.S. Pat. No. 9,009,837 B2 issued Apr. 15, 2015, to Nunez Di Croce for Automated security assessment of business-critical systems and applications;

U.S. Pat. No. 9,128,728 B2 issued on Sep. 8, 2015, to Siman, et al., for Locating security vulnerabilities in source code;

U.S. Pat. No. 9,292,686 B2 issued on Mar. 22, 2016, to Ismael, et al., for Micro-virtualization architecture for threat-aware microvisor deployment in a node of a network environment;

U.S. Pat. No. 9,338,522 B2 issued on May 10, 2016, to Rajgopal, et al., for Integration of untrusted framework components with a secure operating system environment;

U.S. Pat. No. 9,355,253 B2 issued on May 31, 2016, to Kellerman, et al., for Set top box architecture with application based security definitions;

U.S. Pat. No. 9,390,268 B1 issued on Jul. 12, 2016, to Martini, et al., for Software program identification based on program behavior;

U.S. Pat. No. 9,400,889 B2 issued on Jul. 26, 2016, to Chess, et al., for Apparatus and method for developing secure software;

U.S. Pat. No. 9,443,086 B2 issued on Sep. 13, 2016, to Shankar for Systems and methods for fixing application vulnerabilities through a correlated remediation approach;

U.S. Pat. No. 9,473,522 B1 issued on Oct. 18, 2016, to Kotler, et al., for System and method for securing a computer system against malicious actions by utilizing virtualized elements;

U.S. Pat. No. 9,483,648 B2 issued on Nov. 1, 2016, to Cedric, et al., for Security testing for software applications;

U.S. Pat. No. 9,495,543 B2 issued Nov. 15, 2016, to Aad et al. for Method and apparatus providing privacy benchmarking for mobile application development;

U.S. Pat. No. 9,563,422 B2 issued Feb. 7, 2017, to Cragun et al. for Evaluating accessibility compliance of a user interface design;

U.S. Pat. No. 9,602,529 B2 issued Mar. 21, 2017, to Jones et al. for Thread modeling and analysis;

U.S. Pat. No. 9,729,576 B2 issued Aug. 8, 2017, to Lang et al. for Method and system for rapid accreditation/re-accreditation of agile IT environments, for example service oriented architecture (SOA);

U.S. Pat. No. 9,729,583 B1 issued Aug. 8, 2017, to Barday for Data processing systems and methods for performing privacy assessments and monitoring new versions of computer code for privacy compliance;

DENG et al., A privacy threat analysis framework: supporting the elicitation and fulfillment of privacy requirements, Nov. 16, 2010, (https://link.springer.com/article/10.1007/s00766-010-0115-7);

GARLAN, et al., Architecture-driven modelling and analysis, SCS '06 Proceedings of the eleventh Australian workshop on safety critical systems and software—Volume 69, 2006;

LUNA et al., “Privacy-by-Design Based on Quantitative Threat Modeling”, Oct. 10, 2012, Risk and Security of Internet and Systems (CRiSIS) 2012 7th International Conference, Cork, Ireland, (http://ieeexplore.ieee.org/document/6378941/);

REDWINE, Introduction to modeling tools for software security, US-CERT, published on Feb. 21, 2007; and

YUAN, Architecture-based self-protecting software systems, Dissertation, George Mason University, 2016.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram of a security testing system;

FIG. 1B is a block diagram of a threat discovery system;

FIG. 2 is a block diagram of a system for conducting consumption-based security testing in a containerized environment;

FIG. 3A is a flow diagram illustrating the threat analysis process;

FIG. 3B is a flow diagram of a compliance and security threat analysis process;

FIG. 4A is a flow diagram illustrating the architecture discovery process;

FIG. 4B is a flow diagram illustrating an asset inventory and topology creation/update from trace events process;

FIG. 5A is a block diagram of an architecture of a customer's IT and an application compliance monitoring service provider on the cloud;

FIG. 5B is a block diagram of an automated data privacy compliance assessment for applications based on a privacy centric threat modeling approach;

FIGS. 6A-C is a flow diagram of a data privacy analysis flow; and

FIG. 7 is a diagram of a compliance and security threat mitigation process.

### DETAILED DESCRIPTION

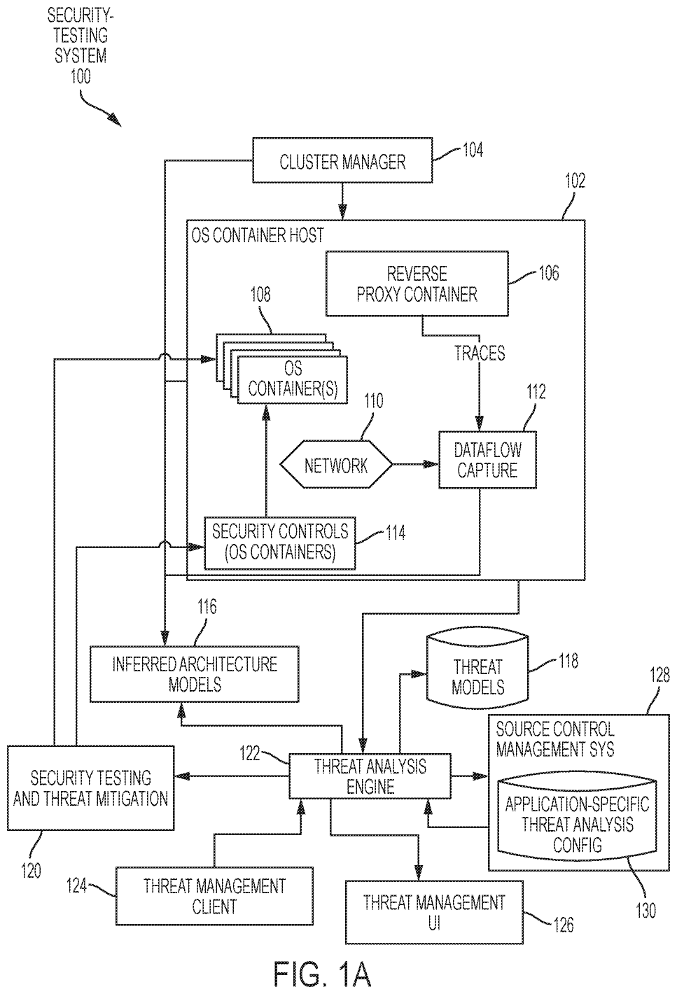

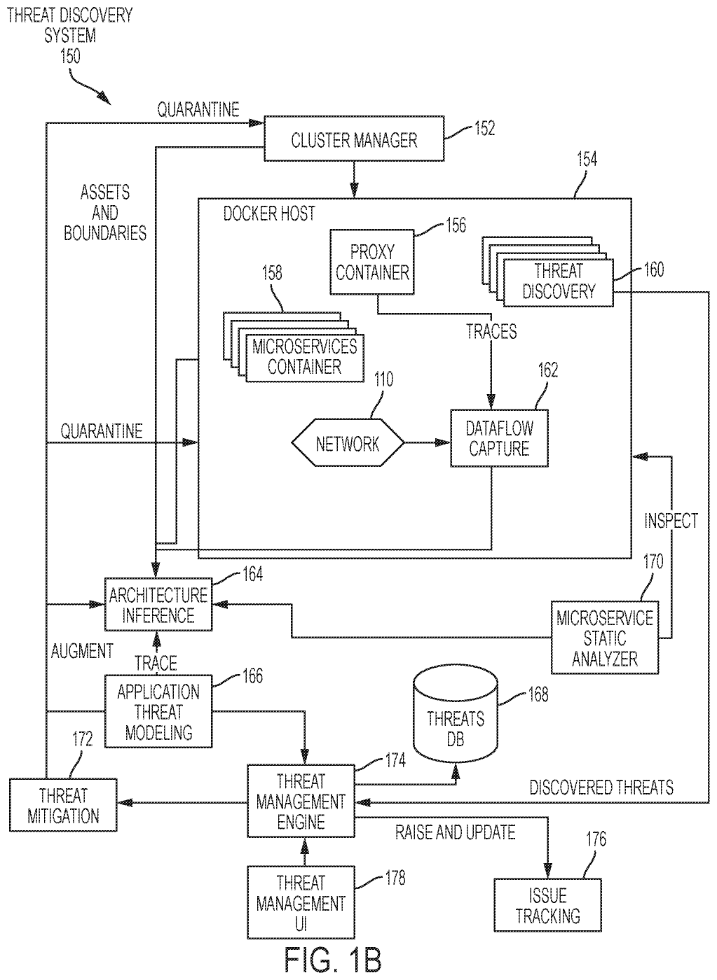

The present disclosure eliminates the need for manual definition of software architecture for security and data privacy threat analysis; obviates missing or incorrect security-related information associated with manually defined software architecture models; eliminates the presence of outdated software architecture models for threat analysis, adds value to the software development lifecycle by providing continuous security testing during and after development of the software; significantly lowers the high entry barrier for non-security experts associated with current solutions; automates the application of the threat model that correctly corresponds with the software architecture currently in place, reduces the difficulties associated with traditional security testing approaches deployed within virtualized execution environment 102 as illustrated in FIG. 1A; provides security functionality corresponding to the current and proposed software architectures and their directly-associated security threats; supplies security-relevant functionality for mitigating threats rapidly and on demand; and supplies programmatic access to threat modeling artifacts and processes. The present disclosure also provides systems and methods for detecting and reporting application and privacy compliance violations at the application level without requiring code modifications. Additionally, the present disclosure provides application compliance and data privacy monitoring systems which transparently detect and report compliance violations at the application level.

FIG. 1A shows a functional block diagram of security-testing system 100 that is representative for various embodiments of the current disclosure. Security-testing system 100 includes a virtualized execution environment 102 (OS container host) hosting one or more containerized application environments 108 (OS containers). The virtualized execution environment 102 also includes dataflow capture software 112, which captures network packet traces (e.g., logging to record information about the program's execution) via a reverse proxy container 106, which is optionally provided, and a network 110, such as a host network. The virtualized execution environment 102 infers data flow from the network packet traces. The one or more containerized application environments 108 receives an input from security controls 114 (OS containers).

Cluster manager 104 is configurable for managing the deployment, execution, and lifecycle of containerized application environment(s) 108 and provides input into the virtualized execution environment 102. The cluster manager 104 is optional. A threat analysis engine 122 is provided for inferring one or more inferred architecture models 116 from flow and execution information and applying threat models to the information to discover threats affecting the virtualized execution environment 102. The threat analysis engine 122 receives input from the virtualized execution environment 102, the source control management system 128, and the threat-management client 124. The inferred architecture models 116 can also receive input from cluster manager 104 and the threat analysis engine 122. A threat model database 118 containing software architecture models, threat models, and threat analysis reports can receive input from the threat analysis engine 122.

Security-testing and threat mitigation service 120 receives an input from the threat analysis engine 122 and provides an output to the containerized application environments 108 in the virtualized execution environment 102 and to the security controls 114. The security-testing and threat mitigation service 120 is configurable for performing security testing, threat mitigation and remediation, and for acting on security issues and performing just-in-time provisioning of security features; security controls 114 act as containerized services for addressing actual or potential threats. The threat-management client 124 manages threat-modeling-related artifacts and runs associated threat analysis processes from a command-line environment. The threat-management client 124 provides an output to the threat analysis engine 122. Threat management user interface 126 provides a user interface (UI) for managing threat-modeling-related artifacts and running associated threat analysis processes via, for example, a web-based user interface. The threat management user interface 126 receives output from the threat analysis engine 122.

A source control management system 128 is provided which includes application-specific threat analysis configuration database 130. The source control management system 128 receives an input from the threat analysis engine 122 and provides an output back to the threat analysis engine 122.

Threat analysis engine 122 is configurable to act upon lifecycle events that originate both directly (from virtualized execution environment 102) and indirectly (from cluster manager 104 that administers OS virtualization-based execution environment). Additionally, the threat analysis engine 122 is configurable to respond to user commands originating from either threat-management client 124 via command line, or threat management user interface 126 via web-based user interface.

For data privacy compliance, the systems, devices and methods operate by modifying the binaries at runtime using a binary instrumentation technique without requiring code modifications. The systems, devices and methods operate by intercepting network traffic among the containers executing within the virtualized environment, therefore without requiring code modifications.

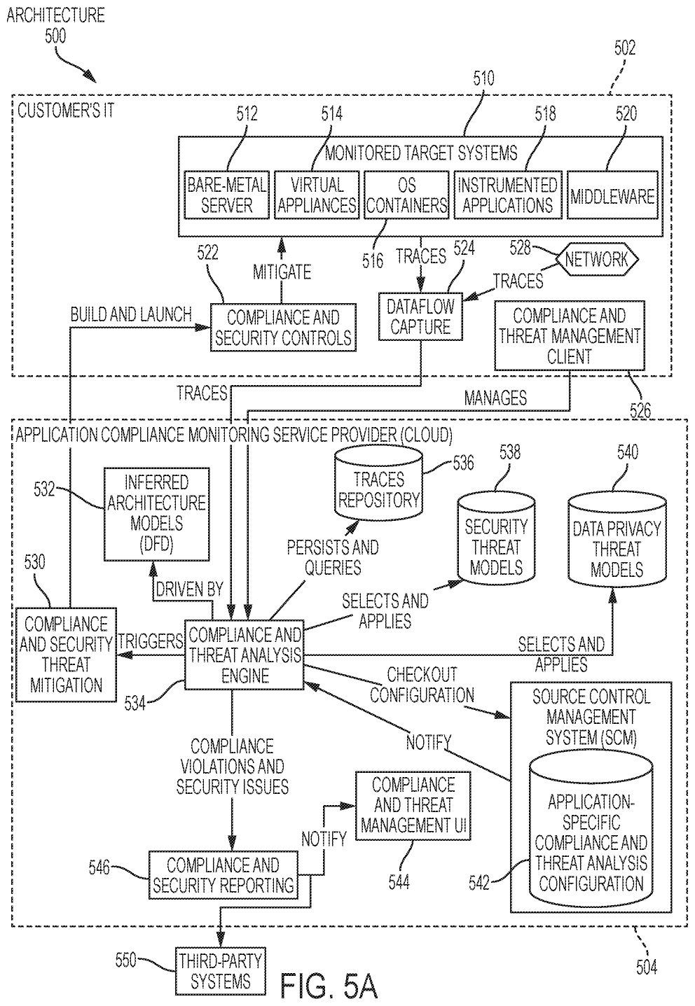

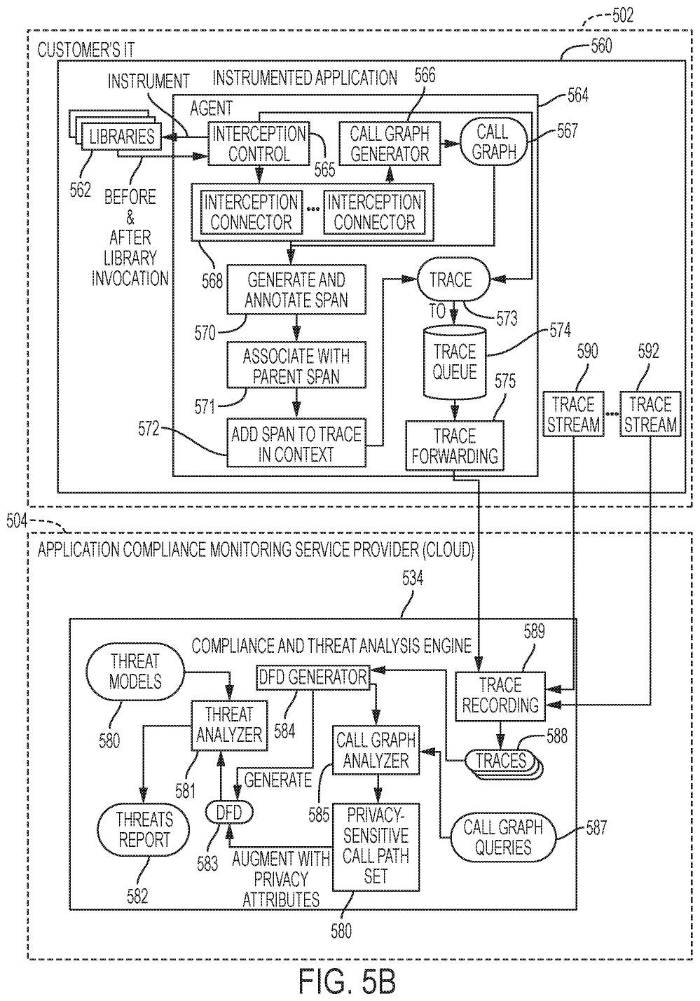

In the event of a triggering event indicating a meaningful change within the execution environment, architecture discovery is performed and stored and the inferred architecture models 116 are updated based on the outcome of this procedure. In the event a change within the monitored execution environment implies a potential security threat, threat analysis is performed using threat models from threat model database 118 for the target applications and the application-specific threat analysis configuration database 130 stored as one or more configuration descriptors within either the local or remotely hosted source control management system 128 of the software to be analyzed. A threat analysis report is created and can be saved to threat model database 118 and an event is raised to listening components. Suitable listening components are shown in FIG. 5A and discussed below.

In the event the discovered threats require introducing additional security controls, security controls 114 are created for the associated threat, deployed and executed within virtualized execution environment 102. Finally, in case discovered threats require either mitigation or remediation, containerized application environment(s) 108 hosting potentially vulnerable services are hardened, partially or totally sequestered, quarantined, or removed.

The containerized security solution provides a privileged access to the control interface of the container infrastructure (e.g., the host). This allows for control of a lifecycle of containers, spawning of new containers, etc. A containerized application can, for example, create a new container image for an application that is running a vulnerable operating system in an existing container where the new container image includes a fix of the operating system. For applications outside the containerized environment, the security solution would access the application binaries and configuration by, for example, mapping a virtual volume in the container to one in the corresponding path within the host.

Both administrative access of the containerized infrastructure and volume mapping are supported by, for example, Docker. The Docker daemon can listen for Docker Engine API requests via three different types of socket: UNIX, TCP and FD. Additional information about Docker can be found at:

https://docs.docker.com/engine/reference/commandline/dockerd/#examples

https://docs.docker.com/engin/admin/volumes/volumes/

The container hosting with a security solution conducting a mitigation or remediation, can also require additional permissions to operate on both the virtualized and host environment. In some configurations, there might be security solutions that do not perform mitigation or remediation. For example, performing an ad-hoc dynamic analysis on a specific application attack surface that has been reported as potentially vulnerable by the threat analysis solution would not necessarily perform a mitigation or remediation. As long as the application endpoints are accessible, these processes would not require special privileges.

FIG. 1B illustrates a block diagram for a threat discovery system 150. The threat discovery system 150 has a cluster manager 152 in communication with a docker host 154, an architecture inference model 164, and a threat mitigation module 172. The docker host 154 has a proxy container 156 which provides traces to a dataflow capture 162. The dataflow capture 162 receives input from a network 110. The docker host 154 also contains one or more microservice containers 158 and one or more threat discovery modules 160. The dataflow capture 162 provides input into the architecture inference model 164. The architecture inference model 164 receives input from the cluster manager 152, the dataflow capture 162, the microservice static analyzer 170, and the application threat modeler 166. The application threat modeler 166 can provide trace input and augmented input to the architecture inference model 164. The application threat modeler 166 can also provide input into the threat management engine 174. The threat management engine 174 can also receive input from threat management UI 178, and discovered threats from the one or more threat discovery modules 160 on the docker host 154. Threat management engine 174 can raise and update issues for issue tracker 176 and can provide output to a threat mitigation module 172.

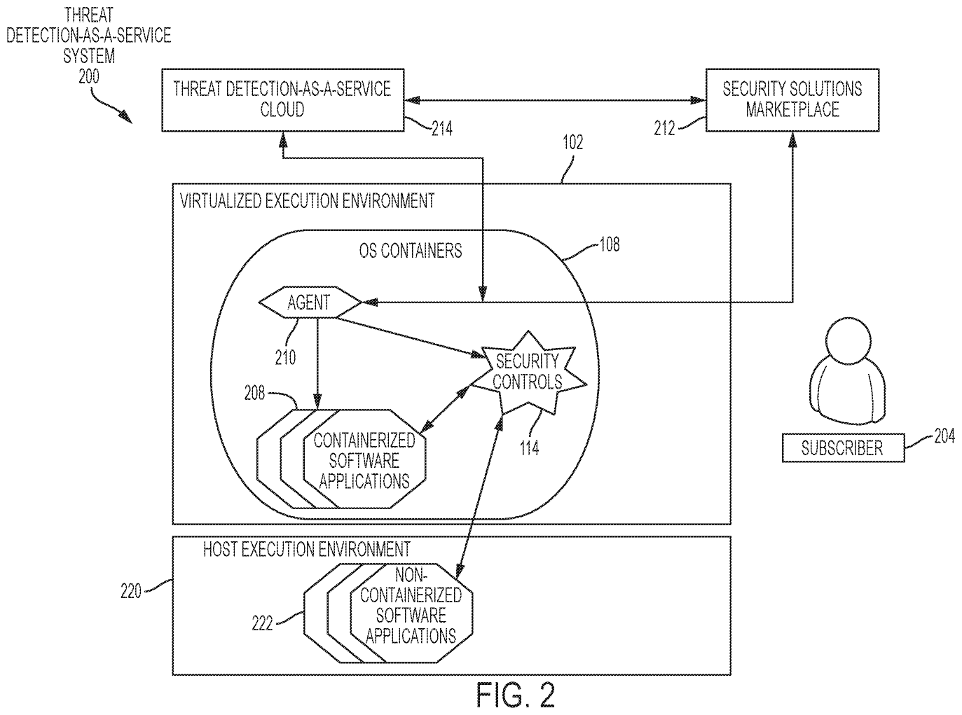

FIG. 2 illustrates an alternate embodiment of the disclosure which is implemented as a threat detection-as-a-service system 200. The threat detection-as-a-service system 200 includes a virtualized execution environment 102, which hosts one or more containerized application environments 108 (OS containers), and a host execution environment 220 which hosts one or more non-containerized software applications 222. Within the one or more containerized application environments 108 resides one or more security controls 114, agent 210, and one or more containerized software applications 208. The agent 210 and one or more containerized software applications 208 are in communication with security controls 114. The one or more non-containerized software applications 222 located in a host execution environment 220, are also in communication with the security controls 114. Security controls 114 can provide information to the one or more containerized software applications 208 and/or one or more non-containerized software applications 222, or receive information from the one or more containerized software applications 208 and/or one or more non-containerized software applications 222. The software applications can be virtualized, as will be appreciated by those skilled in the art. Located externally to the virtualized execution environment 102 and host execution environment 220 are threat detection-as-a-service cloud 214 and security solutions marketplace 212. Both of the threat detection-as-a-service cloud 214 and the security solutions marketplace 212 can be operated as third-party subscriber services and can communicate between each other as well as with, for example, the agent 210 of the virtualized execution environment 102. In this embodiment, agent 210 is configurable to monitor both containerized software applications hosted within the virtualized execution environment 102 and non-containerized software applications 222 hosted within the host execution environment 220, and report meaningful changes occurring within such execution environments to the threat detection-as-a-service cloud 214. The threat detection-as-a-service cloud 214, when required, is configurable to perform automatic threat detection based on both user and vendor supplied threat models. One or more subscribers 204 may access a management and reporting user interface hosted by the cloud service provider (e.g. by accessing a dashboard using a web browser). In configurations where the subscriber accesses a management and reporting user interface an agent 210 would not be required. In addition one or more subscribers 204 may also access various services of threat detection-as-a-service cloud 214 programmatically, through a remote application programming interface (API).

One or more subscribers 204, using a threat detection-as-a-service system 200, may also benefit from a security solutions marketplace 212, which can be cloud-based. The security solutions marketplace 212 may deliver security solutions that address the type of threats that the virtualized execution environment 102 detects for both containerized software applications 208 and non-containerized software applications 222. As one or more threats are detected by the virtualized execution environment 102, one or more security solutions, both registered in the marketplace and capable of addressing reported threats, are suggested to the one or more subscribers 204. One or more subscribers 204 then selects one or more security solutions along with setting configuration parameters for the chosen security solutions. The security solutions marketplace 212 system can build an ad-hoc OS container image—realizing the chosen security control(s) and requesting one or more subscribers 204 infrastructure—through the agent 210—to retrieve and run the generated container within one or more subscribers 204 infrastructure. One or more subscribers 204 would remunerate the security solutions marketplace 212 according to time-based fee of the on-boarded security solutions as well as the consumed resources on the security solutions marketplace.

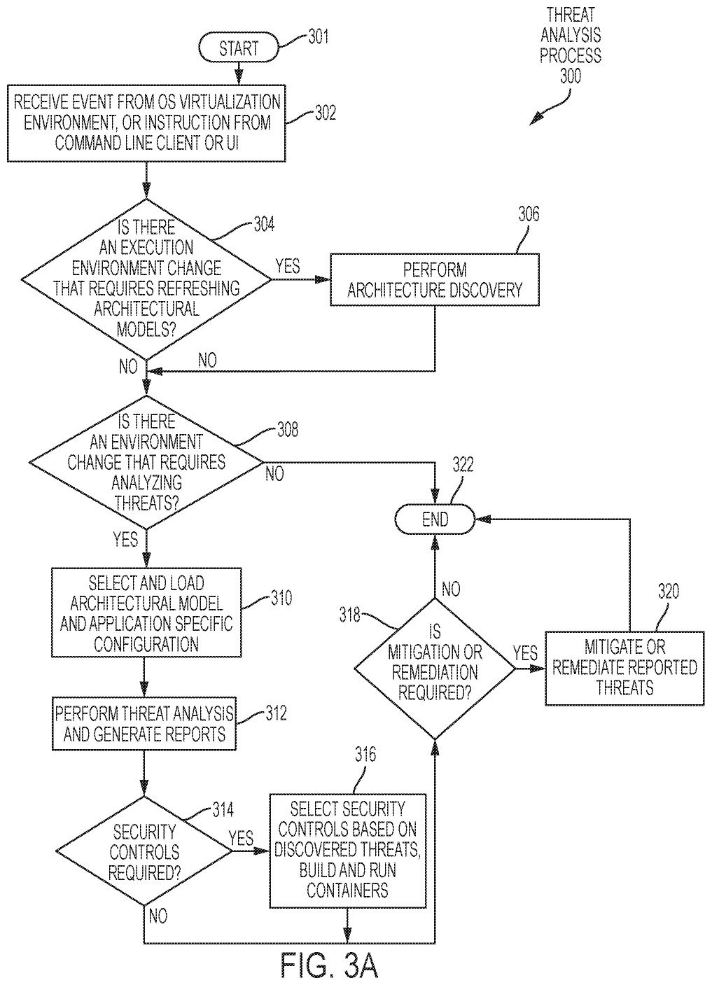

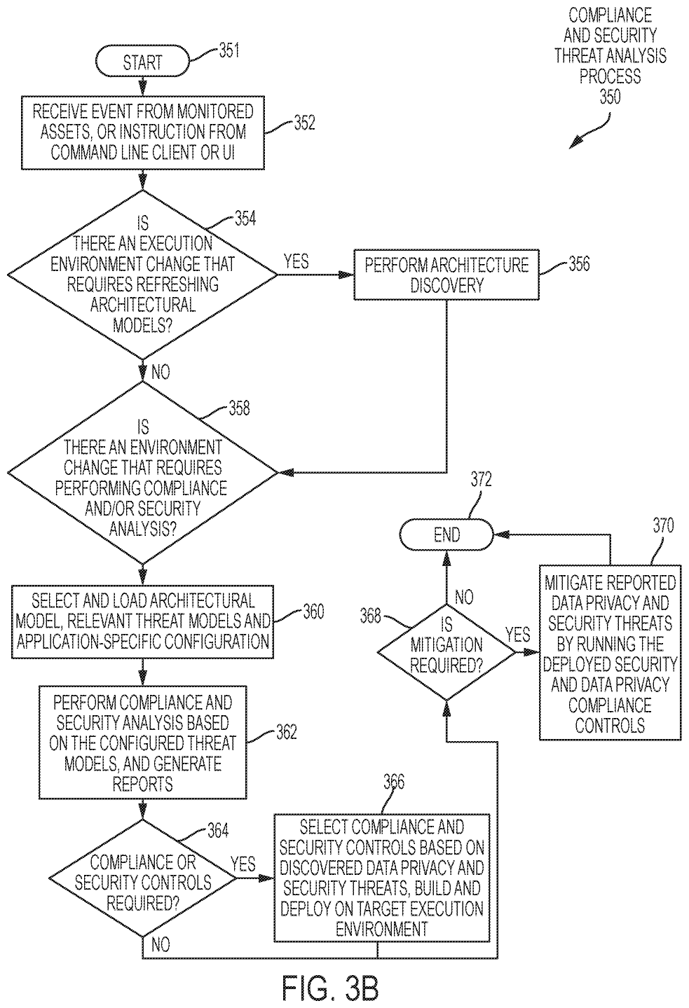

FIG. 3A is a flowchart illustrating an example of threat analysis process 300 of security-testing system 100 of FIG. 1. In the Example of FIG. 3A the operations 302-320 are illustrated as separate, sequential or branched, sequential operations. However, it may be appreciated that any two or more of the operations 302-320 may be executed in a partially or completely overlapping or parallel manner. Further, additional or alternative operations may be included, while one or more operations may be omitted in any specific implementation. In all such implementations, it may be appreciated that various operations may be implemented in a nested, looped, iterative, and/or branched fashion.

Threat analysis process 300 starts 301 upon receipt of an initializing event 302. Initializing event 302 may originate either from the virtualized execution environment 102 of the OS or as an instruction from a command line client or user interface. Additionally, the initializing event 302, can be received from the cluster manager 104, and/or via an instruction from either the threat-management client 124 or the threat management user interface 126. The threat analysis engine 122 listens for events originating from the virtualized execution environment 102 and triggers the analysis procedure in response to detection of an event. The analysis procedure could also be automatically or semi-automatically triggered upon events originating from the source control management system 128 managing the software being analyzed or as a time-based event (e.g. every day at 10 pm).

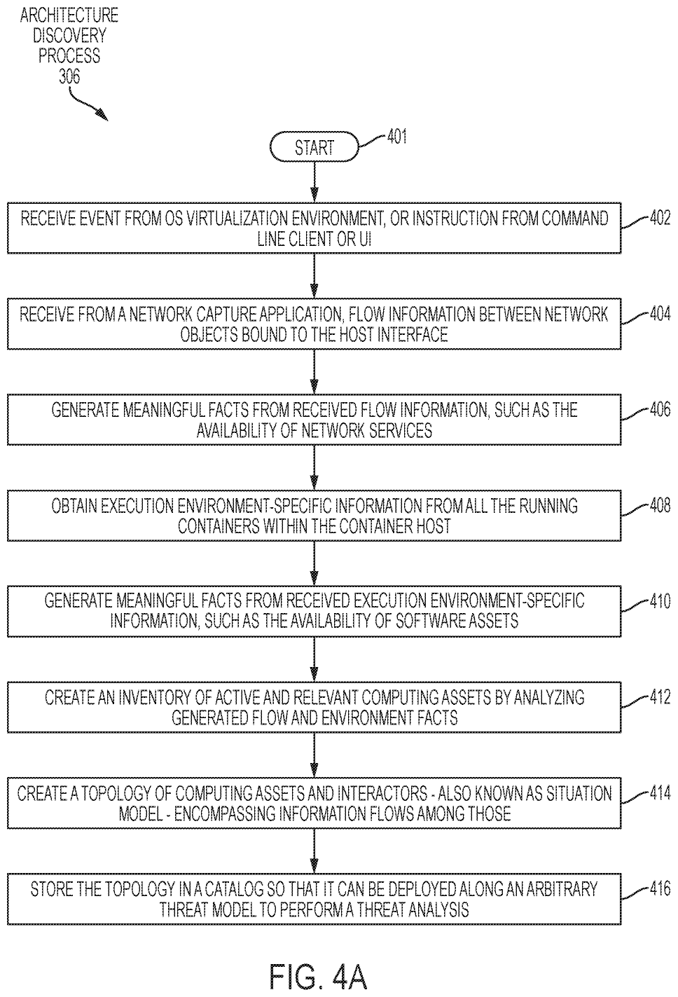

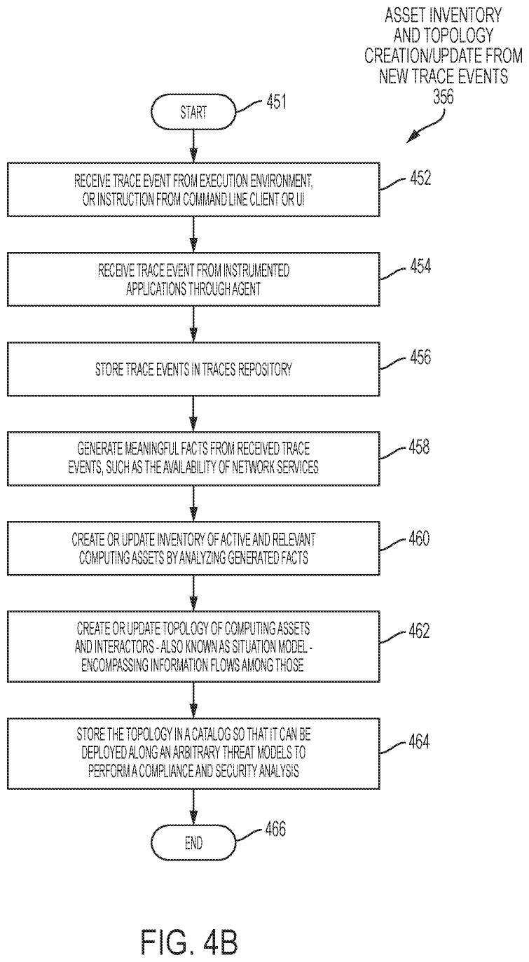

Once an initializing event 302 occurs, an execution environment comparison 304 is performed. The execution environment comparison 304 determines whether there is an execution environment change that requires refreshing architectural models. At this point, the current execution environment is compared to a prior execution environment(s) from the inferred architecture model(s) 116. If a change has occurred in the current execution environment that requires updating architecture model(s) 116 (YES), architecture discovery process 306 is performed as described in detail in FIG. 4A.

Upon completion of architecture discovery process 306, or, if architecture discovery process 306 was not necessary (NO), threat analysis decision 308 is considered. The threat analysis decision 308 determines if there is an environment change that requires analyzing threats. In the event that threat analysis is judged not necessary (NO), threat analysis process 300 reaches a terminus 322 and reverts to waiting for the initializing event 302.

Alternately, if threat analysis is necessary (YES), selection and retrieval of architecture model and relevant threat model(s) and application-specific threat analysis configuration 310 is executed. During this process, application-specific threat analysis configuration database 130 is obtained from the source control management system 128 of the software to be analyzed, which is either hosted locally or remotely. Such application-specific threat analysis configuration database 130 allows augmenting and overriding existent and centrally stored metadata (configuration)—such as discovered architecture models or threat models—or it many fully supersede those. Thereafter, threat analysis and report generation 312 may be performed. As will be appreciated by those skilled in the art, any arbitrary action that is configured in the system may be executed upon the outcome of a threat analysis process. For example, a report can be generated, a support ticket can be opened, a notification can be generated, etc.

Upon completion of threat analysis and report generation 312, security control decision 314 is considered to determine whether security controls are required. In the event that security control(s) are judged necessary (YES), security control selection and implementation 316 is performed. If either security control(s) are not necessary (NO), or, upon completion of security control selection and implementation 316, mitigation and remediation decision 318 is considered to determine whether either or both of mitigation and remediation is required.

If either or both of mitigation and remediation is necessary (YES), quarantine of affected containers can be performed to mitigate and/or remediate reported threats 320. Upon completion of a quarantine of the affected containers to mitigate and/or remediate reported threats 320, or, if mitigation and/or remediation is not required (NO), threat analysis process 300 reaches terminus 322 and reverts to waiting for the initializing event 302. Instead of quarantining the affected containers, the system could disable services that represent an attack surface in order to avoid a complete outage. Additional actions include, for example, hardening vulnerable containers, notifying operations personnel to secure additional action.

FIG. 3B is a flowchart illustrating an example of compliance and security threat analysis process 350 which can be part of the of security-testing system 500 of FIG. 5A. The compliance and security threat analysis process provides for continuously identifying and reporting privacy-related threats and privacy-related compliance breaches in an application. The process provides for application compliance monitoring.

In the example of FIG. 3B the operations 352-370 are illustrated as separate, sequential or branched, sequential operations. However, it may be appreciated that any two or more of the operations 352-370 may be executed in a partially or completely overlapping or parallel manner. Further, additional or alternative operations may be included, while one or more operations may be omitted in any specific implementation. In all such implementations, it may be appreciated that various operations may be implemented in a nested, looped, iterative, and/or branched fashion.

Compliance and security threat analysis process 350 starts 351 upon receipt of an initializing event 352. Initializing event 352 may originate either from monitored assets in, for example, customer's IT 502, or as an instruction from a command line client or user interface. Additionally, the initializing event 352, can be received from the agent 564, and/or via an instruction from either the threat-management client 124 or the threat management user interface 126. The compliance and threat analysis engine 534 listens for events originating from the agent 564 and triggers the analysis procedure in response to detection of an event. In some configurations, the analysis procedure could also be automatically triggered upon events originating from the source control management system 128 managing the software being analyzed or as a time-based event (e.g. every day at 10 pm).

Once an initializing event 352 occurs, an execution environment comparison 354 is performed. The execution environment comparison 354 determines whether there is an execution environment change that requires refreshing architectural models. At this point, the current execution environment is compared to one or more prior execution environments from the inferred architecture model(s) 356. If a change has occurred in the current execution environment that requires updating architecture model(s) 356 (YES), architecture discovery process 306 is performed as described in detail in FIG. 4A.

Upon completion of architecture discovery process 356, or, if architecture discovery needs to be refreshed 354 (NO), the system determines if there is an environment change 358.

After determining whether there is an environment change 358 that requires performing compliance and/or security analysis, the system selects and loads one or more architectural models 360. The loaded one or more architectural models 360 include relevant threat models and application-specific configuration. Once the one or more architectural models 360 are loaded, the system performs compliance and security analysis based on the configured threat model and generates reports 362. Once the compliance and security analysis is complete, the system determines if compliance or security controls are required 364. If compliance or security controls 364 are required (YES), the system selects compliance and security controls based on discovered data privacy and security threats 366. The system may also build and deploy a target execution environment. If compliance or security controls 364 are not required (NO), and once the selects compliance and security controls based on discovered data privacy and security threats 366 is complete, the system determines if mitigation is required 368. If mitigation is required 368 (YES), then the system mitigates reported data privacy and security threats by running one or more deployed security and data privacy control 370. If mitigation is not require (NO), and once the one or more deployed security and data privacy controls has been run, the process terminates 372.

The result of the examples of FIGS. 3A-B provide actionable mitigation and remediation recommendations for threat analysis and meeting security and compliance requirements in a network environment. The systems, devices and methods provide transparent, non-intrusive data privacy compliance monitoring for applications without modifying the target application, application code, or even having access to the application source code. The systems, devices and methods detect and report compliance violations at the application level. Compliance violations include, but are not limited to data privacy and security threats. As will be appreciated by those skilled in the art, per PCI Requirement 6.6, all Web-facing applications should be protected against known attacks. Those attacks are include Spoofing, Tampering, Repudiation, Denial of Service and Elevation of privileges. See, The STRIDE Threat Model published by Microsoft, copyright 2005, available at https://msdn.microsoft.com/en-us/library/ee823878%28v=cs.20%29.aspx?f=255&MSPPError=-2147217396.

The systems, devices and methods can operate in a virtualized environment, such as environments based on operating system virtualization, as well as bare metal environments (e.g., where the instructions are executed directly on logic hardware without an intervening operating system). Continuous data privacy compliance monitoring for applications during development and operation can be achieved without negatively impacting performance of the application. The actionable mitigation strategies allow end users to meet requirements for reporting data privacy issues. The compliance rules are configured as declarative and plug-and-play (PnP) and can be customized based on the end user's needs (e.g., customer needs). The PnP can be just in time. As will be appreciated by those skilled in the art, the systems, devices and methods can operate in a cloud computing environment and/or use a hosted system. Users have the ability to use the internet and web protocols to enable the computing environment to continuously and automatically recognize compliance without user intervention. The PnP functionality allows for more flexibility in terms of performing automatic assessments which might otherwise be beyond a specific regulation, e.g., regulations that are specific to enterprise security guidelines. The software functionality can be delivered as a service in the cloud via the internet or via an intranet.

FIG. 4A is a flowchart illustrating an example of the architecture discovery process 306 identified in FIG. 3A of security-testing system 100 of FIG. 1. In the Example of FIG. 4A the operations 402-416 are illustrated as separate, sequential operations. However, it may be appreciated that any two or more of the operations 402-416 may be executed in a partially or completely overlapping or parallel manner. Additionally, some of the steps can be performed in a different order, while others require a step as a prerequisite (although not necessarily an immediately prior pre-requisite). For example, storing the topology 416 would occur after the topology is ready to store. As will be appreciated by those skilled in the art, any of the tasks could be implemented as a separate operating system process or thread without departing from the scope of the disclosure. Implementing as a separate operating system process enables the systems, devices and methods to achieve a maximum use of computing resources, which facilitates vertical and horizontal scaling of the product and facilitates achieving shortened response times. Further, additional or alternative operations may be included, while one or more operations may be omitted in any specific implementation. In all such implementations, it may be appreciated that various operations may be implemented in a nested, looped, iterative, and/or branched fashion.

In the example of FIG. 4A, once started 401 an initializing event 402 is received. Initializing event 402 may come from either from the cluster manager 104 or the OS container host of the virtualized execution environment 102, and/or via an instruction from either the threat-management client 124 or the threat management user interface 126. Subsequently, in the present example, flow information 404 between network objects bound to the host interface are received from a dataflow capture software 112.

Upon receipt of a significant amount of flow information, flow information facts 406, such as the availability of network services, are generated. Environment specific information 408 pertaining to all running containers within the OS container host of the virtualized execution environment 102 is obtained from the cluster manager 104 and the container host of the virtualized execution environment 102 itself. Environment facts 410 are generated from meaningful facts received from execution environment-specific information, for example, those pertaining to the availability of software assets.

Via analysis of environment specific information 408 and execution of the environment facts 410, an inventory of active and relevant computing assets 412 is synthesized. A topology of computing assets and interactors 414 (also known as a situation model) is created which encompasses information flows among and between active and relevant computing assets 412. The topology of computing assets and interactors 414 is stored in catalog of the topology 416 so that it may be deployed subsequently to perform threat analysis.

FIG. 4B is a flowchart illustrating an example of the architecture discovery process 356 identified in FIG. 3B of a security-testing system 500 of FIG. 5A. In the example of FIG. 4B the operations 452-466 are illustrated as separate, sequential operations. However, it may be appreciated that any two or more of the operations 452-466 may be executed in a partially or completely overlapping or parallel manner. Further, additional or alternative operations may be included, while one or more operations may be omitted in any specific implementation. In all such implementations, it may be appreciated that various operations may be implemented in a nested, looped, iterative, and/or branched fashion.

In the example of FIG. 4B, after starting 451, a trace event 452 is received from an agent 564 or instructions are received from a command line client or user interface. In the present example, trace event information 454 is received from instrumented applications through an agent 564 and the trace events are stored in a trace respository 456.

Once the meaningful facts generated from trace events occurs 458, such as the those encompassing details on data privacy-sensitive operations, an inventory or active and relevant computing assets is created or updated by analyzing generated facts 460. Then the topology of computing assets and interactors—namely a data flow diagram (DFD)—are created or updated 462. The topology and computing assets and interactors is also known as situation models. The situation models encompasses information flow among the computing assets and residing software application objects. The topology is stored in a catalog so that it can be deployed along an arbitrary data privacy-specific threat models to perform a data privacy compliance and security analysis 464. Then the process ends 466.

FIG. 5A illustrates an architecture of a security-testing system 500. The system configuration can include three main components: customer's IT 502 in communication with application compliance monitoring service provider 504, in communication with third party systems 550. As will be appreciated by those skilled in the art, the components of the system can be in direct communication or indirect communication. Additionally, aspects of the system can be on a local server or on a cloud server accessed via the internet.

The customer's IT 502 further can include monitored target systems 510, such as a bare-metal server 512, virtual appliances 514, OS containers 516, instrumented applications 518, and middleware 520. The monitored target systems 510 are further configurable to provide traces to a dataflow capture 524. Additionally, a network 528 can provide traces to the dataflow capture 524. A compliance and threat management client 526 can be included in the customer's IT 502. Both of the dataflow capture 524 and the compliance and threat management client 526 provide traces and manages a compliance and threat analysis engine 534. A compliance and security controls 522 is configurable to obtain information from compliance and security threat mitigation process 530 which is used to build and launch the compliance and security controls 522.

The application compliance monitoring service provider 504 has a compliance and threat analysis engine 534 and receives traces from dataflow capture 524, and managing instructions from a compliance and threat management client 526. The compliance and threat analysis engine 534 provides instructions to an inferred architecture model (DFD) 532. The compliance and threat analysis engine 534 also triggers a compliance and security threat mitigation process 530. The compliance and security threat mitigation process 530, also provides instructions to the compliance and security controls 522 of the customer IT 502 to build and launch. The compliance and threat analysis engine 534 also persists and queries a traces repository 536, selects and applies security threat models 538, selects and applies data privacy threat models 540, and provides a checkout configuration (e.g., working copy) to a source control management system (SCM) which includes application-specific compliance and threat analysis configuration 542. The source control management system notifies the compliance and threat analysis engine 534 of configuration changes that may require an eventual response through the execution of one or more actions. The compliance and threat analysis engine 534 provides an output of compliance violations and security issues to a compliance—such as those related to data privacy—and security reporting module 546 which then notifies compliance and management threat user interface 544 and third party systems 550.

FIG. 5B is a block diagram of an automated data privacy compliance assessment for applications based on a privacy centric threat modeling approach. In the context of the IT security, threat modeling is a structured approach that allows for identifying, quantifying and address the security risks associated with an application. The first step involves modeling the system for which threats have to be identified. This is typically materialized in the DFD (Data Flow Diagram). Then, one or more threat models may be applied to it in order to discover potential vulnerabilities. One of the main friction points for threat modeling is that the DFD has to be generated and kept up-to-date manually. For rapidly evolving medium-to-large systems this can be a significant friction point compromising mainstream adoption. Secondly, the STRIDE (“Spoofing, Tampering, Repudiation, Information Disclosure, Denial of Service and Elevation of Privilege”) methodology—developed by Microsoft®—does not cover data privacy as a potential threat. Even if data privacy has been addressed by the LINDDUN methodology, it still lacks of an approach for automatically identifying data privacy threats. [LIDDUN is a privacy threat analysis framework that consists of six steps focused on the problem space and identifying the privacy threats in the system.] Thirdly, DFD semantics are limited in terms of expressing fine grained—and potentially security relevant—interactions within a single application with its dependencies (e.g. libraries) that do not necessarily translate to a data flow (e.g. remote procedure (RPC) call). This impacts the effectiveness and overall depth of the threat modeling practice as potentially security-relevant information is not gathered nor evaluated. Finally, data privacy compliance at the application level is a manual process that requires both software developers and security personnel to review the corresponding source code. When this is not available it this cannot be achieved and thus potential data privacy compliance issues cannot be addressed.

The disclosed systems, devices and methods reduce the friction with application-level data privacy compliance by leveraging a threat modeling approach featuring a continuous and automated approach built into the systems development life cycle (SDLC) as well as software systems in a production environment. The key enabler for this is the automated discovery of the DFD from one or more streams of traces. Traces can either be generated by both infrastructure and application-level components. An example infrastructure component trace are network packets from a virtualization engine (i.e. hypervisor). Conversely, an example application level trace component is an http flow from an application consuming a third-party service. In terms of the application level coverage, it transparently extracts data flows without modifying the target application, more specifically using binary instrumentation of relevant libraries. Additionally, it can augment traces with security-sensitive call graphs which translate to richer DFDs and associated threat analysis outcomes. Finally, data privacy-sensitive threats can be identified more easily by providing traceability in terms of the privacy-sensitive call graphs associated to a specific flow, therefore allowing for more insights on whether data privacy concerns are being addressed. For instance, by including in a trace record, a call graph generated from a specific encryption function invocation for a data element to be transmitted, it is possible to infer whether confidentiality countermeasures have been applied upon executing such operation.

FIG. 5B includes two blocks from FIG. 5A: customer's IT 502 and Application compliance monitoring service provider (cloud) 504. The customer's IT 502 has one or more instrumented applications 560 and libraries 562 executing within a customer IT infrastructure 502. An agent 564 is injected into the application for modifying its binaries and/or dependencies (i.e. libraries) at runtime. The interception control 565 loads the configured interception connectors 568 and delegates the instrumentation task to each of these. The interception connectors 568 then launches the call graph generator 566 for handling the call graph 567 creation requests from interception connectors 568. The instrumentation task implies injecting into both the beginning and end of a specific operation—such as a class method or function—an invocation to arbitrary logic of the interception connectors 568. Upon the interceptor connectors' logic is invoked, it obtains the trace within the context of the recorded transaction. It can then generate and/or annotate one or more spans 570, attaching it to its parent span 571—in case any—as well as modify existent ones. Spans can be augmented by adding annotations to it and a span can be added to a trace in context 572. Once the trace record 573 is completed, the trace is submitted asynchronously (i.e. non-blocking) to the trace queue 574 and the trace is forwarded 575 to the compliance and threat analysis engine 534. It is worth noting that instrumented applications represent just one source of traces as the trace analysis engine may consume any number of trace streams 590, optionally performing arbitrary joins and aggregations as needed. The trace is persisted 589 in a repository 588 and then harnessed by the DFD generator 584 for updating the DFD graph 583 for a specific tenant. The DFD generator uses the call graph analyzer 585 for interpreting call graphs embedded in spans. It relies on preconfigured call graph queries 587 for producing privacy-sensitive call graph set 586 to for augmenting the DFD. Once the DFD construction is completed, the threat analyzer 581 applies the configured threat models 580 to it, creating the corresponding threat report 582.

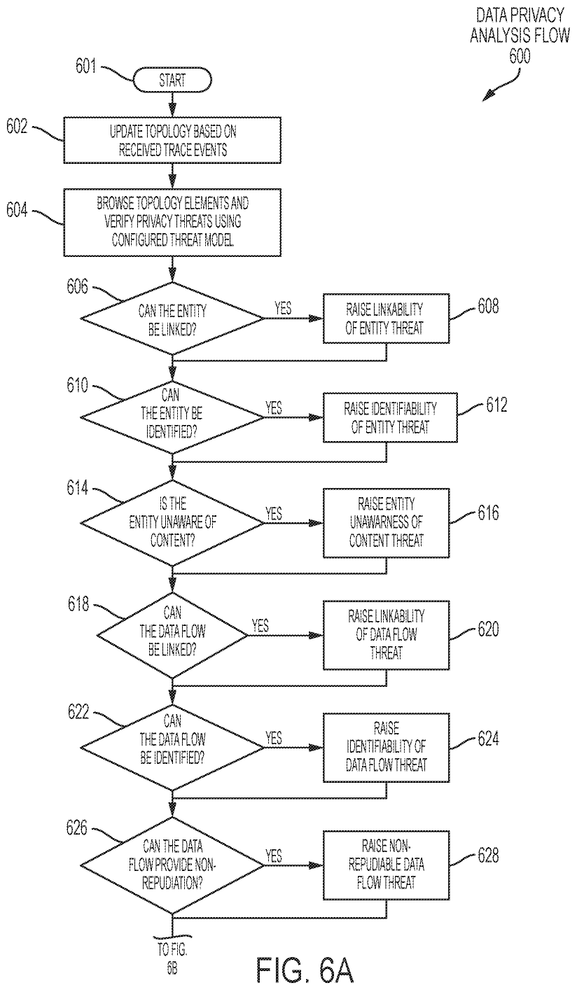

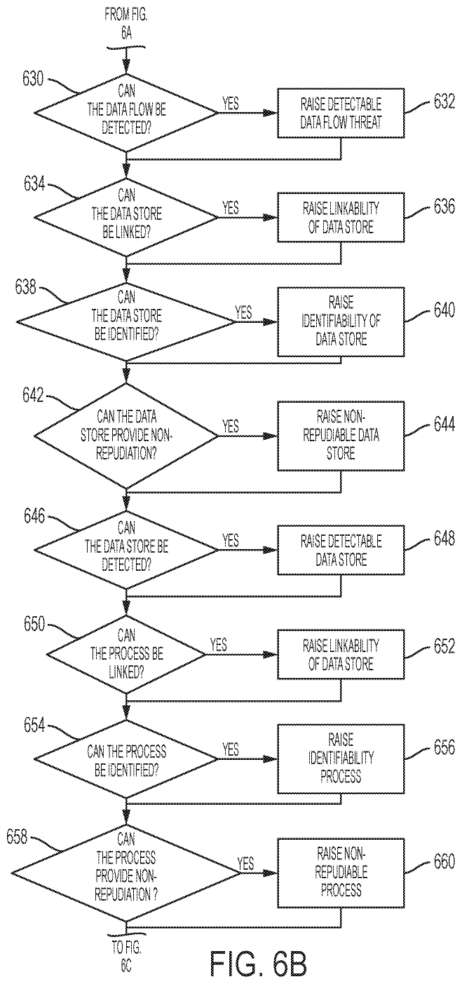

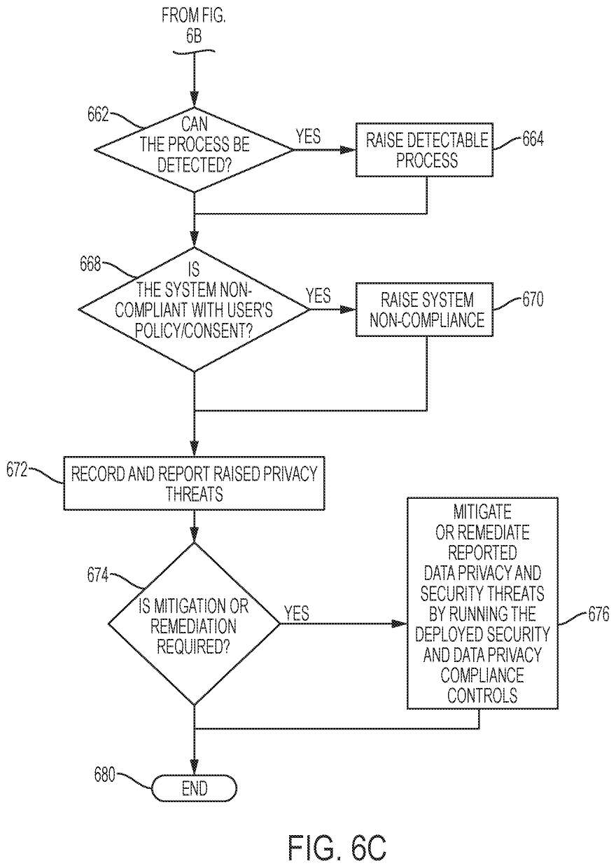

FIGS. 6A-C is a data privacy analysis flow 600. Those of skill in the art will note that the terminology used is based on LINDDUN. The data privacy analysis flow 600 starts 601 with updating topology based on received trace events 602. Once the topology is updated, topology elements are browsed and privacy threats are verified using configured threat models 604. The flow them determines whether the entity can be linked 606. If the entity can be linked (YES), then a linkability score of the entity threat is raised 608. The flow then determines if the entity can be identified 610. If the entity can be identified (YES) then the identifiability of the entity threat score is raised 612. After that determination, the flow determines if the entity is unaware of the content of the threat 614. If the entity is aware of the content (YES), then the entity unawareness of the content threat score is raised 616. From there, it is determined whether the data flow can be linked 618, if the data flow can be linked (YES), then the linkability of the data flow threat score is raised 620. Then the system determines whether the data flow can be identified 622. If the data flow can be identified (YES), the identifiability of data flow threat score is raised 624. Then it is determined if the data flow can provide non-repudiation 626. If the data flow can provide non-repudiation, then a non-repudiable flow threat score is raised 628. Then the system determines whether the data flow can be detected 630. If the data flow can be detected (YES), then the detectable data flow threat score is raised 632. Next it is determined if the data store can be linked 634. If the data store can be linked (YES), then the linkability of the data store score is raised 636. Next the flow determines if the data store can be identified 638. If the data store can be identified (YES), then the identifiability of data store score is raised 640. Then it is determined if the data store can provide non-repudiation 642. If the data store can provide non-repudiation (YES), then a non-repudiable data store score is raised 644. Then it is determined if the data store can be detected 646. If the data store can be detected (YES), then the detectable data store score is raised 648. Then it is determined if the process can be linked 650. If the process can be linked (YES), then the linkability of data store score is raised 652. Then it is determined if the process can be identified 654. If the process can be identified (YES), then an identifiability process score is raised 656. Then it is determined if the process can provide non-repudiation 658. If the process can provide non-repudiation (YES), then a non-repudiable process score is raised 660. Then it is determined if the process can be detected 662. If the process can be detected (YES), then a detectable process score is raised 664. Then it is determined If the system is non-compliant with the user's policy/consent 668, i.e., does the system comply with the policies set for the system by the administrator. If the system is non-compliant (YES), then the systems non-compliance score is raised 670.

At the end of the data privacy analysis flow 600, the system records and reports raised privacy threats 672 identified during the privacy analysis flow. Then the system determines if mitigation is required 674. If the system determines mitigation is required (YES), then the system mitigates reported data privacy and security threats by running the deployed security and data privacy compliance controls 676 and the process ends 680.

As will be appreciated by those skilled in the art, each of the steps shown in FIGS. 6A-C are not required for the flow. Moreover, the steps do not need to be performed in a specific order. For example, there might be a flow which does not imply an interaction with the data store. Where there is no interaction with the data store, the steps which involve the data store (e.g., steps 630-648) would not be required. Although the order of the steps is largely unimportant, there are some steps that should be performed in sequence. For example, record and reports raised privacy threats 672 would occur after the data privacy assessments are performed.

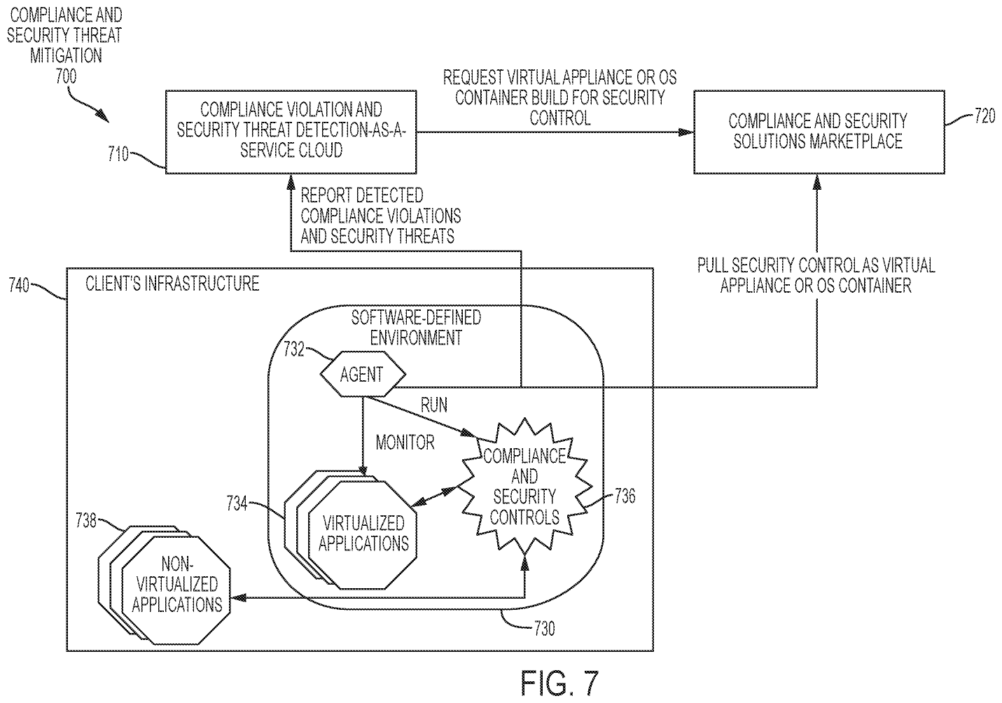

FIG. 7 illustrates a compliance and security threat mitigation system 700. Compliance violation and security threat detection-as-a-service cloud 710, requests virtual appliance or operating system container build for security control from compliance and security solutions marketplace 720. The compliance violation and security threat detection-as-a-service cloud 710 and compliance and security solutions marketplace 720 communications with the client infrastructure 740. The client infrastructure 740 has a software-defined environment 730 which includes an agent 732 which monitors one or more virtualized applications 734 and one or more non-virtualized applications 738 which reside, respectively both inside and outside the software-defined environment 730. The agent 732 also runs compliance and security controls 736 for one or more virtualized applications 734 and one or more non-virtualized applications 738.

The software-defined environment 730 with a security solution conducting a mitigation or remediation, can also require additional permissions to operate outside the virtualized environment, namely in the host environment. In some configurations, there might be security solutions that do not perform mitigation or remediation. For example, performing an ad-hoc dynamic analysis on a specific application attack surface that has been reported as potentially vulnerable by the threat analysis solution would not necessarily perform a mitigation or remediation. As long as the application endpoints are accessible, these processes would not require special privileges. The virtualized applications 734, non-virtualized applications 738 and compliance and security controls 736 are in communication.

The systems and methods according to aspects of the disclosed subject matter may utilize a variety of computer and computing systems, communications devices, networks and/or digital/logic devices for operation. Each may, in turn, be configurable to utilize a suitable computing device that can be manufactured with, loaded with and/or fetch from some storage device, and then execute, instructions that cause the computing device to perform a method according to aspects of the disclosed subject matter.

A computing device can include without limitation a mobile user device such as a mobile phone, a smart phone and a cellular phone, a personal digital assistant (“PDA”), such as an iPhone®, a tablet, a laptop and the like. In at least some configurations, a user can execute a browser application over a network, such as the Internet, to view and interact with digital content, such as screen displays. A display includes, for example, an interface that allows a visual presentation of data from a computing device. Access could be over or partially over other forms of computing and/or communications networks. A user may access a web browser, e.g., to provide access to applications and data and other content located on a website or a webpage of a website.

A suitable computing device may include a processor to perform logic and other computing operations, e.g., a stand-alone computer processing unit (“CPU”), or hard wired logic as in a microcontroller, or a combination of both, and may execute instructions according to its operating system and the instructions to perform the steps of the method, or elements of the process. The user's computing device may be part of a network of computing devices and the methods of the disclosed subject matter may be performed by different computing devices associated with the network, perhaps in different physical locations, cooperating or otherwise interacting to perform a disclosed method. For example, a user's portable computing device may run an app alone or in conjunction with a remote computing device, such as a server on the Internet. For purposes of the present application, the term “computing device” includes any and all of the above discussed logic circuitry, communications devices and digital processing capabilities or combinations of these.

Certain embodiments of the disclosed subject matter may be described for illustrative purposes as steps of a method that may be executed on a computing device executing software, and illustrated, by way of example only, as a block diagram of a process flow. Such may also be considered as a software flow chart. Such block diagrams and like operational illustrations of a method performed or the operation of a computing device and any combination of blocks in a block diagram, can illustrate, as examples, software program code/instructions that can be provided to the computing device or at least abbreviated statements of the functionalities and operations performed by the computing device in executing the instructions. Some possible alternate implementation may involve the function, functionalities and operations noted in the blocks of a block diagram occurring out of the order noted in the block diagram, including occurring simultaneously or nearly so, or in another order or not occurring at all. Aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The instructions may be stored on a suitable “machine readable medium” within a computing device or in communication with or otherwise accessible to the computing device. As used in the present application a machine readable medium is a tangible storage device and the instructions are stored in a non-transitory way. At the same time, during operation, the instructions may at sometimes be transitory, e.g., in transit from a remote storage device to a computing device over a communication link. However, when the machine readable medium is tangible and non-transitory, the instructions will be stored, for at least some period of time, in a memory storage device, such as a random access memory (RAM), read only memory (ROM), a magnetic or optical disc storage device, or the like, arrays and/or combinations of which may form a local cache memory, e.g., residing on a processor integrated circuit, a local main memory, e.g., housed within an enclosure for a processor of a computing device, a local electronic or disc hard drive, a remote storage location connected to a local server or a remote server access over a network, or the like. When so stored, the software will constitute a “machine readable medium,” that is both tangible and stores the instructions in a non-transitory form. At a minimum, therefore, the machine readable medium storing instructions for execution on an associated computing device will be “tangible” and “non-transitory” at the time of execution of instructions by a processor of a computing device and when the instructions are being stored for subsequent access by a computing device.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An apparatus for implementation of a system for modeling and analysis in a computing environment, the apparatus comprising:
a processor and a memory storing executable instructions that in response to execution by the processor cause the apparatus to implement at least:
identify elements of an information system configured for implementation by a system platform, the elements including components and data flows therebetween, the components including one or more of a host, process, data store or external entity;
compose a data flow diagram for the information system, the data flow diagram including nodes representing the components and edges representing the data flows, providing structured information including attributes of the components and data flows;
monitor an environment;
receive a trace from the monitored environment;
create an inventory of active and relevant computing assets;
generate a topology of computing assets and interactions;
store the topology in a catalog; and
identify at least one of a privacy compliance and a security compliance of the monitored environment.

2. The apparatus for implementation of a system for modeling and analysis in a computing environment of claim 1, further comprising:
a compliance analyzer indicator configured to
perform an analysis which includes being configured to:
identify at least one of a measure of the privacy compliance and a measure of the security compliance of the environment, and
identify at least one of a suggested mitigation and a suggested remediation wherein the suggested mitigation and suggested remediation are implementable to reduce at least one of the measure of the privacy compliance and the security compliance to a lower measure of privacy compliance and a lower measure of security compliance.

3. The apparatus for implementation of a system for modeling and analysis in a computing environment of claim 2, further comprising a processor configured to at least one of automatically mitigating the data privacy compliance, automatically mitigating the security compliance, automatically remediating the data privacy compliance, and automatically remediating the security compliance.

4. The apparatus for implementation of a system for modeling and analysis in a computing environment of claim 3, wherein at least one of automatically mitigating the data privacy compliance, automatically mitigating the security compliance, automatically remediating the data privacy compliance, and automatically remediating the security compliance is based on a plug-and-play virtualized control.

5. The apparatus for implementation of a system for modeling and analysis in a computing environment of claim 2, wherein the privacy compliance and the security compliance refers to a circumstance or an event with a likelihood to have an adverse impact on the environment, and the measure of a current risk is a function of measures of the privacy compliance and the security compliance.

6. The apparatus for implementation of a system for modeling and analysis in a computing environment of claim 2, further a processor configured to at least one of transparently monitoring the data privacy compliance, and transparently monitoring the security compliance.

7. The apparatus for implementation of a system for modeling and analysis in a computing environment of claim 6 wherein the at least one of transparently monitoring the data privacy compliance, and transparently monitoring the security compliance includes threat modeling of at least one of the data privacy compliance and the security compliance.

8. The apparatus for implementation of a system for modeling and analysis in a computing environment of claim 2, wherein the data privacy compliance monitoring is achieved with a binary instrumentation.

9. The apparatus for implementation of a system for modeling and analysis in a computing environment of claim 2, wherein the security compliance monitoring is achieved with a network capture.

10. The apparatus for implementation of a system for modeling and analysis in a computing environment of claim 1, wherein a compliance analyzer indicator is configured to:
perform an analysis which includes being configured to:
obtain execution environment-specific information from all the running applications within the environment;
capture a flow of information between network objects; and
generate facts from received flow information.

11. The apparatus for implementation of a system for modeling and analysis in a computing environment of claim 1, further configured to:
generate meaningful facts from received execution environment-specific information.

12. The apparatus for implementation of a system for modeling and analysis in a computing environment of claim 11, wherein generate meaningful facts includes determine the availability of software assets.

13. The apparatus for implementation of a system for modeling and analysis in a computing environment of claim 1, wherein the trace from the monitored environment is at least one of a security-relevant trace and a data privacy-relevant trace from an application through an agent.

14. The apparatus for implementation of a system for modeling and analysis in a computing environment of claim 13, wherein traces are stored in a trace repository.

15. The apparatus for implementation of a system for modeling and analysis in a computing environment of claim 14, wherein one or more traces are joined.

16. A method of implementing a system for modeling and analysis in a computing environment, the method comprising:
activating a processor and a memory storing executable instructions that in response to execution by the processor cause the computing environment to:
identifying elements of an information system configured for implementation by a system platform, the elements including components and data flows therebetween, the components including one or more of a host, process, data store or external entity;
composing a data flow diagram for the information system, the data flow diagram including nodes representing the components and edges representing the data flows, providing structured information including attributes of the components and data flows;
monitor an environment;
receiving a trace from the monitored environment;
creating an inventory of active and relevant computing assets;
generating a topology of computing assets and interactions;
storing the topology in a catalog;
identifying at least one of a privacy compliance and a security compliance of the monitored environment.

17. The method of implementing a system for modeling and analysis in a computing environment of claim 16, further comprising the steps of:
identifying a measure of at least one of the privacy compliance and the security compliance of the environment, and
identifying at least one of a suggested mitigation and a suggested remediation wherein the suggested mitigation and the suggested remediation are implementable to reduce at least one of the measure of the privacy compliance and the security compliance to a lower measure of the privacy compliance and a lower measure of the security compliance.

18. The method of implementing a system for modeling and analysis in a computing environment of claim 17, further comprising the step of at least one of automatically mitigating the data privacy compliance, automatically mitigating the security compliance, automatically remediating the data privacy compliance, and automatically remediating the security compliance.

19. The method of implementing a system for modeling and analysis in a computing environment of claim 18, wherein at least one of automatically mitigating the data privacy compliance, automatically mitigating the security compliance, automatically remediating the data privacy compliance, and automatically remediating the security compliance is based on a plug-and play virtualized control.

20. The method of implementing a system for modeling and analysis in a computing environment of claim 16, wherein the privacy compliance and the security compliance refers to a circumstance or an event with a likelihood to have an adverse impact on the environment, and the measure of a current risk is a function of measures of the privacy compliance and the security compliance.

21. The method of implementing a system for modeling and analysis in a computing environment of claim 16, further comprising the step of at least one of transparently monitoring the data privacy compliance, and transparently monitoring the security compliance.

22. The method of implementing a system for modeling and analysis in a computing environment of claim 21, wherein the step of at least one of transparently monitoring the data privacy compliance, and transparently monitoring the security compliance includes threat modeling of at least one of the data privacy compliance and the security compliance.

23. The method of implementing a system for modeling and analysis in a computing environment of claim 16, wherein the data privacy compliance monitoring is achieved with a binary instrumentation.

24. The method of implementing a system for modeling and analysis in a computing environment of claim 16, wherein the security compliance monitoring is achieved with a network capture.

25. The method of implementing a system for modeling and analysis in a computing environment of claim 16, further comprising one or more of:
obtaining execution environment-specific information from all the running containers within the container host;
capturing a flow of information between network objects; and
generating facts from received flow information.

26. The method of implementing a system for modeling and analysis in a computing environment of claim 16, further comprising:
generating meaningful facts from received execution environment-specific information.

27. The method of implementing a system for modeling and analysis in a computing environment of claim 26, wherein generating meaningful facts includes determining the availability of software assets.

28. The method of implementing a system for modeling and analysis in a computing environment of claim 16, wherein the trace from the monitored environment is at least one of a data privacy trace and security-relevant trace from an application through an agent.

29. The method of implementing a system for modeling and analysis in a computing environment of claim 28, wherein the traces are stored in a trace repository.

30. The method of implementing a system for modeling and analysis in a computing environment of claim 29, wherein one or more traces are joined.

31. A computer-readable storage medium for implementing a system for modeling and analysis in a computing environment, the computer-readable storage medium being non-transitory and having computer-readable program code portions stored therein that in response to execution by a processor, cause an apparatus to at least:
identify elements of an information system configured for implementation by a system platform, the elements including components and data flows therebetween, the components including one or more of a host, process, data store or external entity;
compose a data flow diagram for the information system, the data flow diagram including nodes representing the components and edges representing the data flows, providing structured information including attributes of the components and data flows;
monitor an environment;
receive a trace from the monitored environment;
create an inventory of active and relevant computing assets;
generate a topology of computing assets and interactions;
store the topology in a catalog;
identify at least one of a privacy compliance and a security compliance of the monitored environment.

32. The computer-readable storage medium for implementing a system for modeling and analysis in a computing environment of claim 31, further comprising computer-readable program code to:
identify at least one of a measure of the privacy compliance and a measure of the security compliance of the environment, and
identify at least one of a suggested mitigation and a suggested remediation wherein the suggested mitigation and the suggested mediation are implementable to reduce at least one of the measure of privacy compliance and the security compliance to a lower measure of privacy compliance and a lower measure of security compliance.

33. The computer-readable storage medium for implementing a system for modeling and analysis in a computing environment of claim 31, further comprising computer-readable program code to at least one of automatically mitigating the data privacy compliance, automatically mitigating the security compliance, automatically remediating the data privacy compliance, and automatically remediating the security compliance.

34. The computer-readable storage medium for implementing a system for modeling and analysis in a computing environment of claim 33, wherein at least one of automatically mitigating the data privacy compliance, automatically mitigating the security compliance, automatically remediating the data privacy compliance, and automatically remediating the security compliance is based on a plug-and-play virtualized control.

35. The computer-readable storage medium for implementing a system for modeling and analysis in a computing environment of claim 32, wherein the privacy compliance and a security compliance refers to a circumstance or an event with a likelihood to have an adverse impact on the environment, and the measure of current risk is a function of measures of the privacy compliance and a security compliance.

36. The computer-readable storage medium for implementing a system for modeling and analysis in a computing environment of claim 32, further comprising computer-readable program code to at least one of transparently monitoring the data privacy compliance, and transparently monitoring the security compliance.

37. The computer-readable storage medium for implementing a system for modeling and analysis in a computing environment of claim 36, wherein computer-readable program code to at least one of transparently monitoring the data privacy compliance, and transparently monitoring the security compliance includes threat modeling of at least one of the data privacy compliance and the security compliance.

38. The computer-readable storage medium for implementing a system for modeling and analysis in a computing environment of claim 32, wherein the data privacy compliance monitoring is achieved with a binary instrumentation.

39. The computer-readable storage medium for implementing a system for modeling and analysis in a computing environment of claim 32, wherein the security compliance monitoring is achieved with a network capture.

40. The computer-readable storage medium for implementing a system for modeling and analysis in a computing environment of claim 31, further comprising one or more of:
obtain execution environment-specific information from all the running containers within the container host; and
capture a flow of information between network objects; and generating facts from received flow information.

41. The computer-readable storage medium for implementing a system for modeling and analysis in a computing environment of claim 31, further comprising:
generate meaningful facts from received execution environment-specific information.

42. The computer-readable storage medium for implementing a system for modeling and analysis in a computing environment of claim 41, wherein generate meaningful facts includes determining the availability of software assets.

43. The computer-readable storage medium for implementing a system for modeling and analysis in a computing environment of claim 31, wherein the trace from the monitored environment is at least one of a data privacy trace and security-relevant trace from an application through an agent.

44. The computer-readable storage medium for implementing a system for modeling and analysis in a computing environment of claim 43, wherein the traces are stored in a trace repository.

45. The computer-readable storage medium for implementing a system for modeling and analysis in a computing environment of claim 44, wherein one or more traces are joined.
